(19) United States
(12) Patent Application Publication
(10) Pub. No.: US 2006/0261128 A1
(43) Pub. Date: Nov. 23, 2006

(54) Pressing tongue for nails in the magazine for nail gun

(76) Inventor: Ming-Han Wen, Hsinchu (TW)

Correspondence Address: Ming-Han Wen, 235 Chung-Ho, Box 8-24, Taipei, TW

(21) Appl. No.: 11/130,051

(22) Filed: May 17, 2005

(51) Int. Cl. B25C 5/06

(52) U.S. Cl. 227/137; 227/120

(57) ABSTRACT

A pressing tongue for nails in the magazine for a nail gun, wherein the magazine is installed on the nail gun for loading chained nails, a magazine seat is formed on the bottom of the magazine, and the two ends of the magazine seat is respectively linked with a guiding seat and an arm on the bottom of a handle, a loading stage with a central axle is pivotally formed on the magazine seat to orient the chained nails and put the nails into the guiding seat, a cover is provided for covering the magazine seat. The pressing tongue on an end of the cover extends to close to the central axle, so as to supply the chained nails steadily and smoothly in the process of actuating.

### BACKGROUND OF THE INVENTION

1. Field of the Invention

The present invention is related to a nail pressing tongue in a magazine for a nail gun, and especially to a technique using a nail pressing tongue to press, hold and orient the chained nails.

2. Description of the Prior Art

Chained nails used in the markets for a nail gun are made by equidistantly separating the nails and welding with iron wires, the nails on the iron wires are arrayed sequentially to form a shape of a chain, and are wound and piled to form either of two shapes—cone, cylinder; they are placed in a magazine for the nail gun for receiving the chained nails, and are wound and placed in a nail guiding seat, and then are delivered into a nozzle for actuating.

In order to render the above stated magazine to suit longer and shorter chained nails, in the techniques available in the markets, some use a loading stage being able to adjust the height of the chained nails loaded and being provided on a seat of the magazine, hence by raising and lowering the loading stage, the height for loading longer or shorter chained nails can be obtained by adjustment.

However in practical use of the above structure, when the chained nails are exhausted gradually, the number of circles that the chained nails are piled to attain is gradually reduced, at this time, the chained nails on the outermost circle have a larger tolerance of loosening, especially when the chained nails loaded in a magazine are formed to get a shape of cylinder, under a strong impact force every time a nail is shot, the chained nails continuously shake and leap vigorously, the ends of the chained nails on the outermost circle are subjected to be tangled in the gaps of the chained nails on the inner circles, and are unable to be wound and placed in the nail guiding seat, and even a cumbersome problem that the nails are blocked can be resulted, such structure needs improvement in haste.

In view of this, the inventor developed the present invention based on his specific experience of years in producing nail guns, and after thorough thinking and tests.

### SUMMARY OF THE INVENTION

The primary object of the present invention is to provide a nail pressing tongue in a magazine for a nail gun to press, hold and orient the chained nails to thereby solve the above stated problem.

To get the above object, the present invention mainly is provided on an end of a cover of a magazine with a nail pressing tongue which extends to a neighboring central protruding axle; by pressing, holding and orienting [symbol] the chained nails in the magazine with the nail pressing tongue, the chained nails can be smoothly supplied during actuating.

The present invention will be apparent in its structure, features and functions obtained after reading the detailed description of the preferred embodiment thereof in reference to the accompanying drawings.

### BRIEF DESCRIPTION OF THE DRAWINGS

FIG. 1 is a partial sectional perspective view of the present invention, showing a state that a magazine of a nail gun is installed with a nail pressing tongue;

FIG. 2 is a sectional view of the magazine of the present invention showing the magazine is provided therein with a lower chamber with a radius “R”, and an upper chamber with a radius “r”;

FIG. 2a is a sectional view taken from a section line A-A of FIG. 2, and illustrates that the cross section of a press abutting area is arciform;

FIG. 2b is another sectional view taken from a section line A-A of FIG. 2, and illustrates that the cross section of the press abutting area is in the shape of “U”;

FIG. 3 is a sectional view of the magazine of the present invention showing a state that chained nails in the shape of a cylinder are loaded in the magazine;

FIG. 4 is another sectional view of the magazine of the present invention showing a state that chained nails in the shape of a cone are loaded in the magazine;

FIG. 5 is a top view of the present invention showing a state that the chained nails are wound around a central protruding axle of a loading stage and placed in a nail guiding seat;

FIG. 6 is a partial sectional view showing the magazine of the present invention receives the chained nails, and showing the press abutting area presses, holds and orients the chained nails when the chained nails are exhausted gradually and the radius “R′” of each chained nail is reduced to an amount smaller than that of the radius “r” of the bottom of the upper chamber.

### DETAILED DESCRIPTION OF THE PREFERRED EMBODIMENT

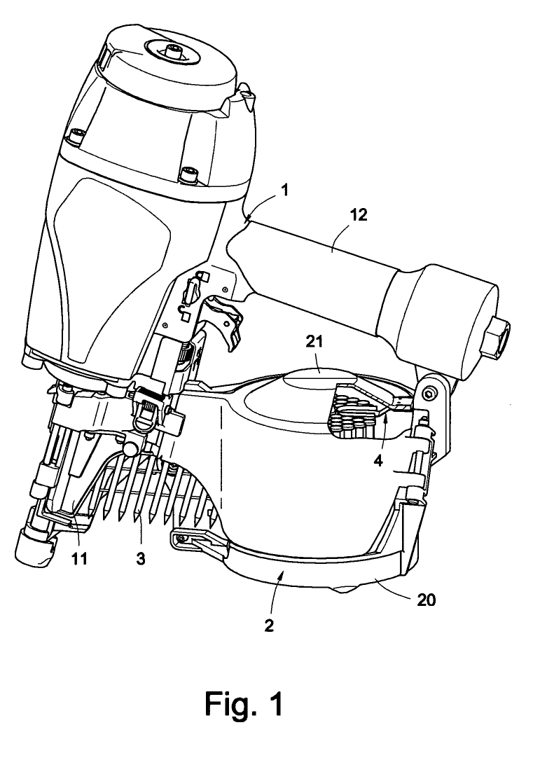

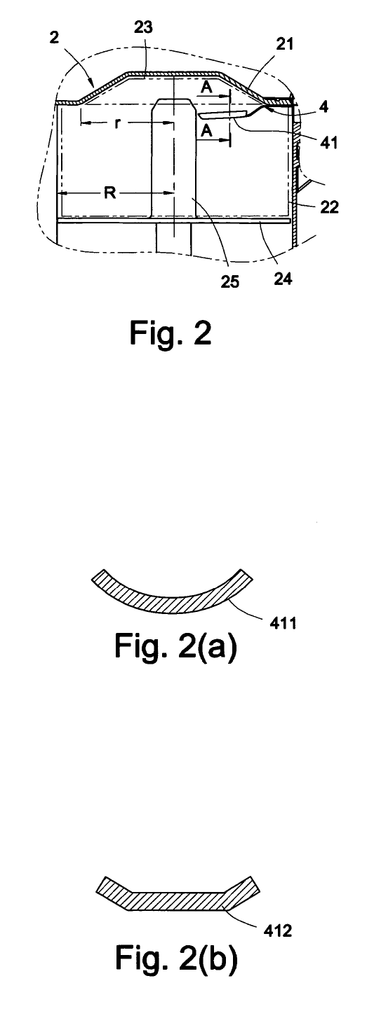

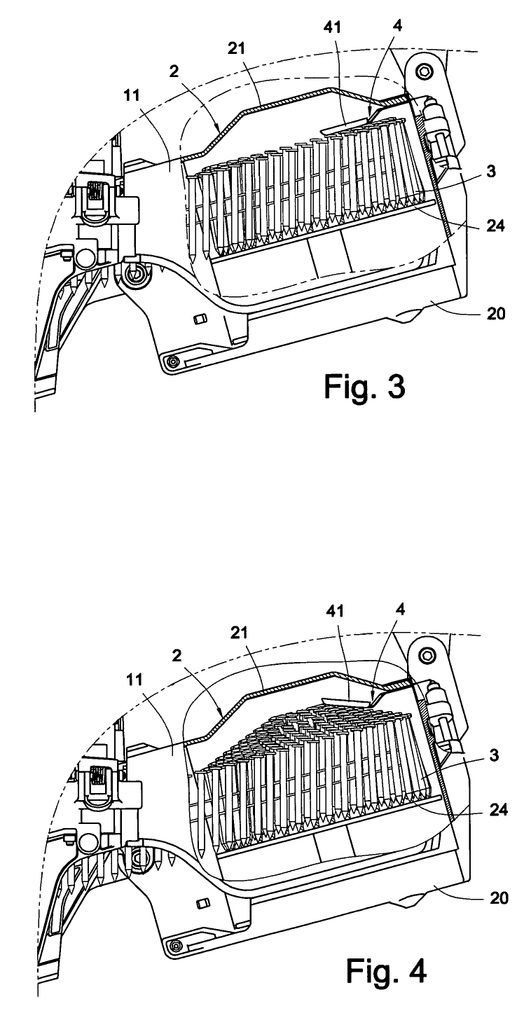

Referring firstly to FIG. 1 that shows the relationship of assembling between a nail pressing tongue of the magazine 2 of the present invention and various members on the magazine 2, wherein a nail gun 1 is installed with the magazine 2 for loading chained nails 3 (referring also to FIGS. 2 and 3); the magazine 2 is provided on its bottom with a magazine seat 20, and two ends of the magazine 2 are respectively connected with a bottom end of a nail guiding seat 11 and an end on the bottom of a handle 12 for fixing the magazine 2; a cover 21 is pivotally provided near the magazine seat 20 on the bottom of the handle 12.

The interior of the magazine 2 (as shown in FIG. 2) can be divided into a lower chamber 22 and an upper chamber 23; the radius of the lower chamber 22 is “R”, and the radius of the bottom of the upper chamber 23 is “r”.

The magazine seat 20 is pivotally provided thereon with a loading stage 24 adapted to adjusting the height of the chained nails 3 loaded (as shown in FIG. 3), so that the loading stage 24 can be raised and lowered to get suitable height for loading longer or shorter chained nails 3; the loading stage 24 has thereon a central protruding axle 25 (as shown in FIG. 2), for positioning the chained nails 3 loaded on the loading stage 24 (as shown in FIGS. 3 and 4).

The cover 21 has a nail pressing tongue 4 clamped on one end of it (as shown in FIG. 2), in this embodiment, the nail pressing tongue 4 is an elastic metallic spring leaf, the nail pressing tongue 4 further is formed thereon a press abutting area 41 which is extended to the top of the lower chamber 22 near the central protruding axle 25, the press abutting area 41 has an arciform cross-section 411 (as shown in FIG. 2a) to allow it to press, hold and orient the chained nails 3 in the magazine 2 in favor of keeping steady and smooth supplying of the chained nails 3 during actuating. Further in practicing, the press abutting area 41 can also be formed to have a “U” shaped cross-section 412 (as shown in FIG. 2b), this can get an identical effect.

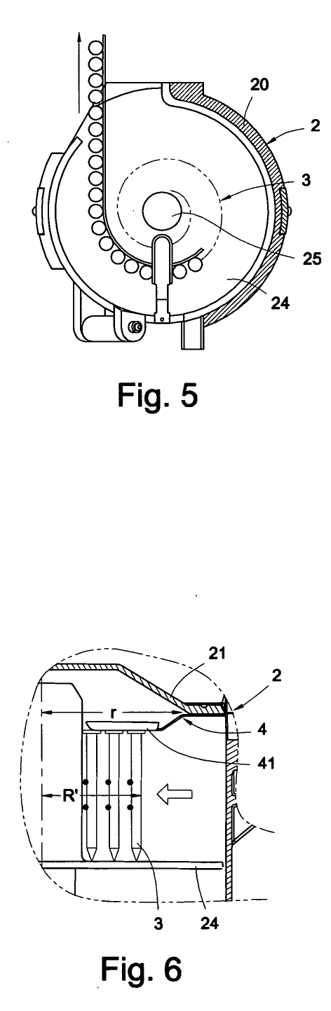

Under the above arrangement of members, the magazine 2 can receive two kinds of chained nails 3 including a conic and a cylindrical shape (as shown in FIGS. 3 and 4); and the central protruding axle 25 on the loading stage 24 is used to position the chained nails 3 to render the latter able to be wound around the central protruding axle 25 and placed in the nail guiding seat 11 (as shown in FIG. 5) for shooting the nails 3 in actuating.

When the chained nails 3 are exhausted gradually, the number of circles that the chained nails 3 are piled to attain is gradually reduced relatively (as shown in FIG. 6), especially when the radius “R′” of each of the chained nails 3 loaded in the magazine 2 and in the shape of a cylinder is reduced to an amount smaller than that of the radius “r” of the bottom of the upper chamber, the press abutting area 41 presses, holds and orients the chained nails 3 in the magazine 2, the influence of the strong impact force to the chained nails 3 every time when the chained nails 3 are shot is reduced to the minimum, this is benefit to keeping steady and smooth supplying of the chained nails 3 during actuating.

In conclusion, the present invention has been described in details about its technical scheme and its high utility in practicing; While the embodiment given is only for illustrating the present invention, and not for giving any limitation to the scope of the present invention; it will be apparent to those skilled in this art that various modifications or changes without departing from the spirit of this invention shall also fall within the scope of the appended claims.

1. A nail pressing tongue in a magazine for a nail gun, wherein said nail gun is installed with said magazine for loading chained nails; said magazine is provided on its bottom with a magazine seat for fixing said magazine; a cover is pivotally provided near said magazine seat on the bottom of a handle; said nail pressing tongue is characterized in that:
said cover is provided on an end thereof with a nail pressing tongue, said nail pressing tongue is formed thereon a press abutting area which is extended to be close to a central protruding axle to press, hold and orient said chained nails in said magazine.

2. The nail pressing tongue in a magazine for a nail gun as claimed in claim 1, wherein said press abutting area has an arciform cross-section.

3. The nail pressing tongue in a magazine for a nail gun as claimed in claim 1, wherein said press abutting area has a cross-section in the shape of “U”.

4. The nail pressing tongue in a magazine for a nail gun as claimed in claim 1, wherein said magazine seat is pivotally provided thereon with a loading stage adapted to adjusting height, so that said loading stage is adapted to adjusting to get a height suitable for loading longer or shorter chained nails.

5. The nail pressing tongue in a magazine for a nail gun as claimed in claim 4, wherein said loading stage has thereon said central protruding axle for positioning said chained nails, said chained nails are wound around said central protruding axle and placed in a nail guiding seat.

6. The nail pressing tongue in a magazine for a nail gun as claimed in claim 1, wherein two ends of said magazine are respectively connected with a bottom end of a nail guiding seat and an end on the bottom of a handle.
